(19) United States
(12) Patent Application Publication
(10) Pub. No.: US 2026/0243395 A1
(43) Pub. Date: Aug. 20, 2026

(54) A LED FILAMENT LAMP

(71) Applicant: SIGNIFY HOLDING B.V., EINDHOVEN (NL)

(72) Inventors: TIES VAN BOMMEL, HORST (NL); RIFAT ATA MUSTAFA HIKMET, EINDHOVEN (NL); ROBERT JACOB PET, WAALRE (NL)

(21) Appl. No.: 19/164,658

(22) PCT Filed: Mar. 7, 2024
(86) PCT No.: PCT/EP2024/056112

§ 371 Date: Sep. 12, 2025

(30) Foreign Application Priority Data
Mar. 16, 2023 (EP) 23162216.8

(51) Int. Cl. F21K 9/232; F21K 9/64; F21K 9/66; F21V 3/08; F21V 9/38; F21Y 103/10; F21Y 115/10

(52) U.S. Cl. CPC F21K 9/232; F21K 9/64; F21K 9/66; F21V 3/08; F21V 9/38; F21Y 2103/10; F21Y 2115/10

(57) ABSTRACT

A LED filament lamp (1) providing, in operation, LED filament lamp light and comprising a LED filament (21-24) emitting, in operation, LED filament light and comprising LEDs (3-6) emitting, in operation, LED light and arranged on an elongated carrier (7-10), an elongated encapsulant (11-14) covering the plurality of LEDs (3-6) and at least part of the elongated carrier (7-10), the elongated encapsulant (11-14) comprising a first luminescent material (38) configured to convert at least a part of the LED light into converted light and/or a light scattering material (39) configured to scatter at least a part of the LED light into scattered light, a base (17) configured to, electrically and mechanically, connect the LED filament lamp (1) to a socket (51) of a luminaire (50), a translucent envelope (15) at least partly enclosing said LED filament (21-24) and mounted to the base (17), and the translucent envelope (15 ) comprising a second luminescent material (37) which comprises one or more of an organic phosphor (41) and quantum dots (42) distributed in a polymer matrix (40), the second luminescent material (37) being configured to convert a part of the LED filament light into converted LED filament light, and having an absorption in the visible wavelength range of which at least 80% is in the blue and green wavelength range, such that the translucent envelope (15) is perceived as having an amber color.

### FIELD OF THE INVENTION

The invention relates to a LED filament lamp providing, in operation, LED filament lamp light and comprising a LED filament emitting, in operation, LED filament light and comprising a plurality of LEDs emitting, in operation, LED light and arranged on an elongated carrier, and an elongated encapsulant covering the plurality of LEDs and at least part of the elongated carrier.

It is noted that as used herein, the terms “blue” and “blue wavelength range” especially relate to light having a wavelength in the range of about 430-495 nm (including some violet and cyan hues). The terms “green” and “green wavelength range” especially relate to light having a wavelength in the range of about 495-560 nm. The terms “yellow” and “yellow wavelength range” especially relate to light having a wavelength in the range of about 560-590 nm. The terms “orange” and “orange wavelength range” especially relate to light having a wavelength in the range of about 590-620 nm. The terms “red” or “red wavelength range” especially relate to light having a wavelength in the range of about 620-780 nm. The term “amber” may refer to one or more wavelengths selected from the range of about 580-605 nm, such as about 590-600 nm. The term “visible wavelength range” is intended to refer to a wavelength range of 400-800 nm.

### BACKGROUND OF THE INVENTION

A trend in lighting is LED filament lamps. An LED filament lamp is an LED lamp which is designed to resemble a traditional incandescent light bulb with a visible filament for aesthetic and light distribution purposes, but with the high efficiency of light-emitting diodes.

A LED filament is providing LED filament light and comprises a plurality of light emitting diodes (LEDs) arranged in a linear array. Preferably, the LED filament has a length L and a width W, wherein L>5 W. The LED filament may be arranged in a straight configuration or in a non-straight configuration such as for example a curved configuration, a 2D/3D spiral or a helix. Preferably, the LEDs are arranged on an elongated carrier like for instance a carrier, that may be rigid (made from, e.g., a polymer, glass, quartz, metal or sapphire) or flexible (e.g., made of a polymer or metal, e.g., a film or foil).

In case the carrier comprises a first major surface and an opposite second major surface, the LEDs are arranged on at least one of these surfaces. The carrier may be reflective or light transmissive, such as translucent and preferably transparent.

As used herein, the terms carrier and elongated carrier may be used interchangeably, such that the elongated carrier may also simply be denoted carrier.

The LED filament may comprise an encapsulant at least partly covering at least part of the plurality of LEDs. The encapsulant may also at least partly cover at least one of the first major surface and second major surface. The encapsulant may be a polymer material which may be flexible such as for example a silicone. Further, the LEDs may be arranged for emitting LED light, e.g., of different colors or spectrums. The encapsulant may comprise a luminescent material that is configured to convert at least a part of the LED light into converted light. The luminescent material may be a phosphor such as an inorganic phosphor and/or quantum dots or rods (further referred to as QDs).

The LED filament may comprise multiple sub-filaments.

WO 2020/161070 A1 discloses a LED filament lamp comprising an LED filament configured to emit LED filament light and an envelope comprising a light absorbing material configured to absorb light in a wavelength range of 400-440 nm to provide an amber colored appearance. The envelope at least partly encloses the LED filament of the LED filament lamp. The light absorbing material is transmissive for substantially all the visible LED-filament light having wavelengths longer than 440 nm. The LED filament may further comprise a luminescent material provided in an encapsulant enclosing the LED strip.

Many such LED filament lamps have an amber coating on its envelope for providing a vintage or nostalgic look. However, the amber coating absorbs LED filament light.

It is therefore desired to improve the performance and/or appearance of LED filaments in LED filament lamps, and in particular in LED filament lamps configured to have a vintage or nostalgic look.

US 2022/078892 discloses an LED light bulb comprising a lamp housing, a bulb base, connected to the lamp housing, a spectral distribution of the light bulb is generally between a wavelength range of about 400 nm to 800 nm, and three peak wavelengths P1, P2, and P3 appear in wavelength ranges corresponding to light emitted by the light bulb, wherein a wavelength of the peak P1 is between 430 nm and 480 nm, a wavelength of the peak P2 is between 480 nm and 530 nm, a wavelength of the peak P3 is between 630 nm and 680 nm.

### SUMMARY OF THE INVENTION

It is an object of the present invention to overcome this problem, and to provide an LED filament lamp with an improved performance and/or appearance of the LED filaments within such a LED filament lamp, and in particular such a LED filament lamp configured to have a vintage or nostalgic look.

According to a first aspect of the invention, this and other objects are achieved by means of a LED filament lamp providing, in operation, LED filament lamp light and comprising a LED filament emitting, in operation, LED filament light and comprising a plurality of LEDs emitting, in operation, LED light and arranged on an elongated carrier, an elongated encapsulant covering the plurality of LEDs and at least a part of the elongated carrier, wherein the elongated encapsulant comprises at least one of a first luminescent material configured to convert at least a part of the LED light into converted light and a light scattering material configured to scatter at least a part of the LED light into scattered light, where the LED filament light comprises the converted light and/or the scattered light, a base configured to, electrically and mechanically, connect the LED filament lamp to a socket of a luminaire, a translucent envelope at least partly enclosing said LED filament and mounted to the base, and where the translucent envelope comprises a second luminescent material, the second luminescent material comprising one or more of an organic phosphor and quantum dots distributed in a polymer matrix, where the second luminescent material is configured to convert a part of the LED filament light into converted LED filament light, and where the second luminescent material has an absorption in the visible wavelength range of which at least 80% is in the blue and green wavelength range, such that the translucent envelope is perceived as having an amber color.

Thereby, and in particular by providing the translucent envelope with a second luminescent material as described above, an LED filament lamp with a reduced loss of light, especially at the translucent envelope, and further with an improved performance and/or appearance of the LED filaments within such a LED filament lamp is provided for. Note that the word translucent also includes transparent. Such a LED filament lamp is further provided with a particularly well-functioning vintage or nostalgic look.

In embodiments, the second luminescent material may have an absorption in the visible wavelength range of which at least 85%, preferably at least 90%, more preferably 93%, most preferably at least 95% is in the blue and green wavelength range, such that the translucent envelope is perceived as having an amber color.

The absorption of the second luminescent material in the visible wavelength range may be higher in the blue wavelength range than in the green wavelength range.

It is noted that this embodiment applies to a case where the second luminescent material is or comprises quantum dots distributed in a polymer matrix. Thereby, a LED filament lamp is provided which in an OFF-state, in which the LED filament does not emit LED filament light, is provided with an improved appearance.

The second luminescent material may comprise an absorption in the visible wavelength range of which at least 55% preferably at least 58%, more preferably at least 60%, is in the green wavelength range and at least 25%, preferably at least 28%, more preferably at least 30%, is in the blue wavelength range.

It is noted that this embodiment applies to a case where the second luminescent material is or comprises an organic phosphor distributed in a polymer matrix. Thereby, a LED filament lamp is provided which in an OFF-state, in which the LED filament does not emit LED filament light, is provided with an improved appearance.

The second luminescent material may be configured to convert 3% to 30%, preferably 3to 15%, of the LED filament light.

Thereby, a small amount of LED filament light is converted, which in turn provides for a LED filament lamp with an improved, that is longer, lifetime and an improved visibility of the LED filaments.

The LED filament light may be white light having a first correlated color temperature (CCT1), wherein CCT1≤2500 K.

By using LED filament light with such a very low CCT, it is ensured that a low amount of LED filament light will be converted by the second luminescent material. This in turn ensures that the CCT of the resulting LED filament lamp light will also be kept in a sufficiently low value CCT-region to be agreeable for perception by the human eye and thus suitable for providing LED filament lamp light resembling that of traditional vintage lamps, and especially incandescent lamps.

The LED filament light may be white light having a first correlated color temperature (CCT1), wherein the LED filament lamp light is white light having a second correlated color temperature (CCT2), and wherein CCT2−CCT1≤500 K.

Thereby it is ensured that CCT of the resulting LED filament lamp light will only be shifted a small amount towards cooler CCTs, thereby keeping the CCT of the LED filament lamp light in a sufficiently low value CCT-region to be agreeable for perception by the human eye and thus suitable for providing LED filament lamp light resembling that of traditional vintage lamps, and especially incandescent lamps.

The polymer matrix may comprise non-luminescent nano-particles, especially non-luminescent nano-particles having a diameter shorter than the visible wavelength range.

By providing such non-luminescent nano-particles, the converted LED filament light may be scattered out of the envelope, while ensuring that the envelope remains translucent. Thereby a high degree of visibility of the LED filament is ensured.

The second luminescent material may comprise one or more of a first phosphor configured to emit first phosphor light having a first dominant wavelength (DW1) in the wavelength range of 550-580 nm, and a second phosphor configured to emit second phosphor light having a second dominant wavelength (DW2) in the wavelength range of 500-550 nm. In an example, the dominant wavelength (DW) of converted light emitted by a phosphor may if considering a correlated color diagram be defined as the wavelength at which a line (L) drawn through (i) the color coordinates of the converted light and (ii) point x=0.333 and y=0.333 intersects the spectrum locus (i.e. at the boundary of the correlated color diagram).

This may be realized if the second luminescent material is or comprises an organic phosphor distributed in the polymer matrix, the second luminescent material may comprise an absorption in the visible wavelength range of which at least 55% preferably at least 58%, more preferably at least 60%, is in the green wavelength range and at least 25%, preferably at least 28%, more preferably at least 30%, is in the blue wavelength range. The second luminescent material is configured to convert 3% to 30%, or 3% to 15%, of the LED filament light. The second luminescent material may comprise a first (organic/QD) phosphor, such as a first (organic/QD) phosphor comprising Lumogen F-240, a second (organic) phosphor, such as a second (organic/QD) phosphor comprising Lumogen F-083, or both an first (organic/QD) phosphor and a second (organic/QD) phosphor comprising Lumogen F-240 and Lumogen F-083. The second luminescent material 37 may further be configured to provide no or substantially no or hardly any scattering of the LED filament light.

Such phosphors have been shown to be particularly efficient in providing the desired amber appearance of the LED filament lamp.

The LED filament may be free from an organic phosphor and quantum dots, and the translucent envelope may be free from an inorganic phosphor.

Thereby a LED filament lamp is provided with a further improved performance and/or appearance of the LED filaments within such a LED filament lamp, while the envelope is still perceived as amber in color. Such a LED filament lamp is further provided with an even more well-functioning vintage or nostalgic look.

The LED filament comprises an OFF-state, in which the LED filament does not emit LED filament light, and an ON-state, in which the LED filament emits LED filament light. The LED filament may both in the OFF-state and in the ON-state be visible through the translucent envelope.

Thereby, a LED filament lamp is provided which comprises a high degree of visibility of the LED filament and an improved appearance both in the OFF-state and in the ON-state.

The first luminescent material may comprise one or more of a green-yellow inorganic phosphor configured to emit green-yellow light and a red inorganic phosphor configured to emit red light. The inorganic phosphor may be a phosphor which does not comprise organic phosphor or QDs.

Such phosphors have been shown to be particularly efficient and well-functioning in providing the LED filament light with the desired parameters, especially the desired CCT and wavelength spectrum.

The green-yellow inorganic phosphor may comprise one or more of a YAG phosphor and a LuAG phosphor, and the red inorganic phosphor may comprise a KSiF phosphor.

The elongated carrier may be light-transmissive, and a further encapsulant may be provided on a second side of the carrier opposite to a first side of the carrier on which the plurality of LEDs is arranged, the further encapsulant comprises at least one of a further luminescent material configured to convert at least a part of the LED light and/or converted light into further converted light and a further light scattering material configured to scatter at least a part of the LED light and/or converted light into further scattered light.

Thereby, absorption of LED filament light in the carrier is avoided. This in turn provides for an LED lamp with an improved intensity of the LED filament lamp light.

The translucent envelope may comprise a glass envelope, and the second luminescent material may be provided as a coating on the glass envelope.

Thereby, a LED filament lamp which is particularly simple to produce is provided for.

The translucent envelope may comprise a neck, the neck forming a part of the translucent envelope being attached to the base, and the neck may be free from the second luminescent material.

Thereby, a LED filament lamp is provided which, especially in the OFF-state, is provided with a look which visually resembles a vintage lamp even closer.

The second luminescent material may be configured to provide no or substantially no scattering.

Thereby, it is ensured that the LED filament is still clearly visible through also the second luminescent material.

The LED filament lamp may comprise a plurality of LED filaments.

The plurality of LED filaments may be identical. Alternatively, the plurality of LED filaments may be mutually different, for instance in terms of color, length, and/or light conversion properties.

Thereby, the LED lamp may be provided with LED filament structures having a wide variety of appearances.

The invention further relates to a luminaire comprising at least one LED filament lamp according to the invention.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 shows a perspective view of an LED filament lamp according to the invention provided with a first luminescent material and a second luminescent material.

FIG. 2 shows a perspective and more detailed view of an exemplary LED filament of the LED filament lamp according to FIG. 1.

FIG. 3 shows a schematical close-up view of an exemplary second luminescent material.

FIG. 4 shows a graph illustrating the absorption coefficient (dashed line) and the emission spectrum (full line), respectively, of a number of different suitable phosphors plotted as normalized intensity as a function of the wavelength of incident light.

FIG. 5 shows a graph illustrating the spectrum of light as a function of wavelength resulting from a LED filament according to the invention as perceived by a viewer.

FIG. 6 shows a cross-sectional side view of a luminaire comprising a LED filament lamp according to the invention.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

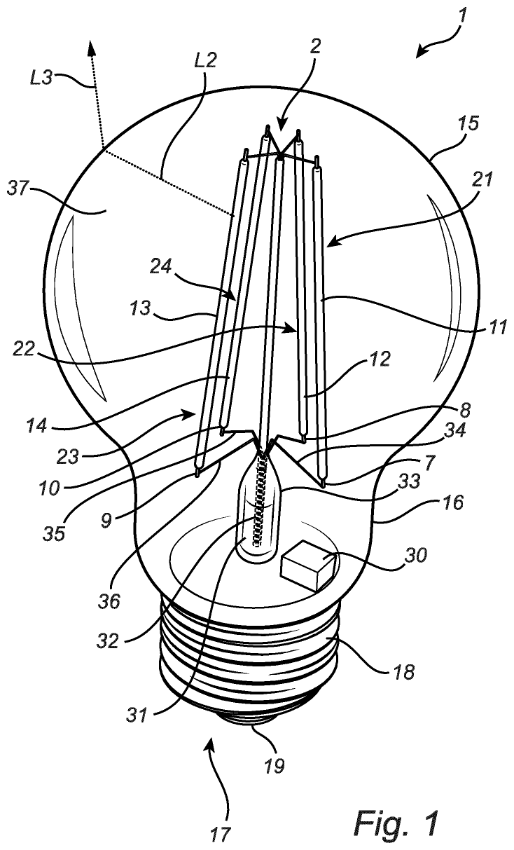

Referring to FIG. 1, an exemplary LED filament lamp 1 according to the invention is shown. The LED filament lamp 1 is configured to, in operation, emit LED filament lamp light L3. The LED filament lamp 1 is shown in the form of a light bulb. The LED filament lamp 1 comprises a LED filament arrangement 2. In the embodiment shown, the LED filament arrangement 2 comprises substantially straight filaments 21-24. The filaments 21-24 of such a LED filament arrangement 2 may in other embodiments be filaments with another shape, such as, but not limited to, spiral-shaped, helix-shaped, meandering, twisted, flat and combinations thereof. In the embodiment shown the LED filament lamp 1 comprises four LED filaments 21, 22, 23, 24. In other embodiments, the LED filament lamp 1 may comprise another number of LED filaments, whether lower or higher than four, such as one, two, three or five LED filaments. Each LED filament 21-24 is configured to, in operation, emit LED filament light L2.

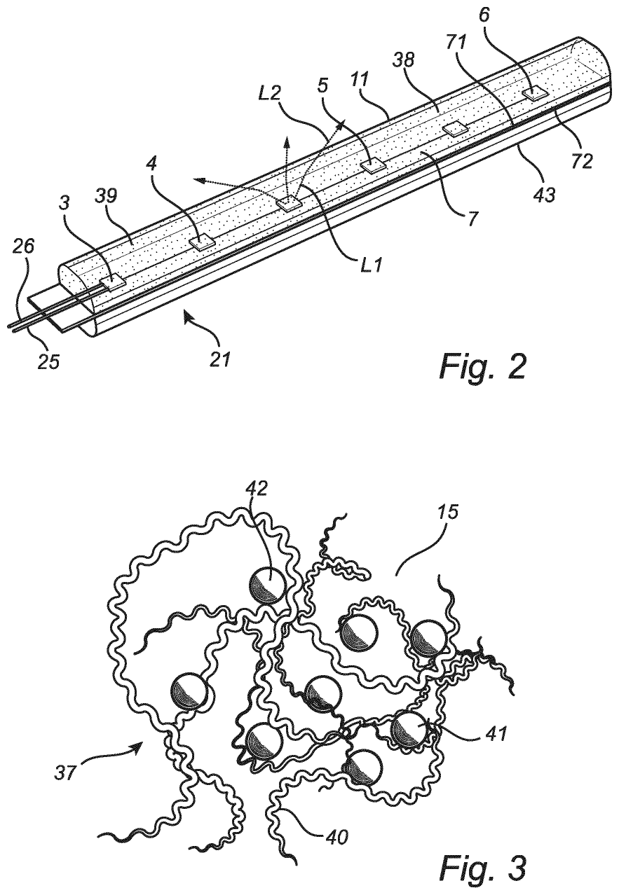

Referring also to FIG. 2, the LED filaments 21-24 each comprise a plurality of LEDs 3, 4, 5 and 6. The plurality or pluralities of LEDs 3-6 are configured to emit, in operation, LED light L1. The respective plurality of LEDs 3-6 is arranged on a respective elongated carrier 7, 8, 9, 10, particularly on a first side 71 of the elongated carrier 7-10.

An elongated encapsulant 11, 12, 13, 14 is provided. As is better seen in FIG. 2, the respective elongated encapsulant 11-14 covers a respective plurality of LEDs 3-6 and at least part of the associated elongated carrier 7-10. The respective elongated encapsulant 11-14 is thus arranged at the side, particularly first side 71, of the respective elongated carrier 7-10, on which the respective plurality of LEDs 3-6 is arranged. Each elongated encapsulant 7-10 comprises one or both of a first luminescent material 38 configured to at least partly convert the LED light L1 into converted LED light and a light scattering material 39 configured to at least partly scatter the LED light into scattered LED light. The first luminescent material 38 may comprise a yellow inorganic phosphor, a red inorganic phosphor, such as a red inorganic phosphor comprising KSiF phosphor, or a combination of an inorganic yellow phosphor and a inorganic red phosphor such as YAG and KSiF. The inorganic phosphor may be a phosphor which does not comprise organic phosphor or QDs.

Thus, the LED filament light L2 comprises the converted LED light and/or the scattered LED light as well as LED light L1. Generally, the LED filament light L2 comprises a first correlated color temperature CCT1, and the first correlated color temperature CCT1 is smaller than or equal to 2500 K.

The elongated carrier 7-10 comprises electrical wiring 25 and 26 (cf. FIG. 2) for supplying electrical energy to the plurality of LEDs 3-6 mounted thereon. The elongated carrier 7-10 may be a substrate or a printed circuit board (PCB).

The elongated carrier 7-10 may further be light-transmissive. In such a case, an encapsulant 43 may be provided on a second side 72 of the carrier 7-10 opposite to the first side 71 of the carrier 7-10 on which the plurality of LEDs 3-6 is arranged. Optionally the encapsulant 43 may also comprise one or more of a luminescent material similar or identical to the first luminescent material 38 described above, and a light scattering material similar or identical to the light scattering material 39 described above. Alternatively, the encapsulant 43 may comprise at least one of a further luminescent material configured to convert at least a part of the LED light and/or converted light into further converted light and a further light scattering material configured to scatter at least a part of the LED light and/or converted light into further scattered light.

Referring again to FIG. 1, the LED filament lamp 1 further comprises a translucent envelope 15 at least partially enveloping the at least one LED filament arrangement 2. The translucent envelope 15 may be shaped in any feasible shape, for example such as to resemble the shape of any one of a standard light bulb, a globe light bulb, a candle light bulb, a customized light bulb and even a spiral light bulb. The translucent envelope 15 comprises a second luminescent material 37. Referring also to FIG. 3, the second luminescent material 37 comprises one or more of an phosphor 41 distributed in a polymer matrix 40 and quantum dots 42 distributed in a polymer matrix 40. The polymer matrix 40 may further comprise non-luminescent nanoparticles. The non-luminescent nanoparticles may have a diameter shorter than the visible wavelength range. The second luminescent material 37 is configured to partly convert the LED filament light L2 into converted LED filament light. Thus, the LED filament lamp light L3 comprises LED filament light L2 and converted LED filament light. The second luminescent material 37 comprises such an absorption that at least 80% of the absorption in the visible wavelength range is in the blue and green wavelength range. Thereby, the translucent envelope 15 is provided with an amber color as perceived by a viewer. The second luminescent material 37 may be provided as a coating on the translucent envelope 15. Alternatively, or additionally, the second luminescent material may be provided in the bulk of the translucent envelope 15. The second luminescent material 37 may further be provided with a gradient in thickness or concentration over the translucent envelope 15.

If the second luminescent material 37 is or comprises quantum dots 42 distributed in the polymer matrix 40, the absorption of the second luminescent material 37 in the visible wavelength range is higher in the blue wavelength range than in the green wavelength range. If the second luminescent material 37 is or comprises an organic phosphor 41 distributed in the polymer matrix 40, the second luminescent material 37 may comprise an absorption in the visible wavelength range of which at least 55% preferably at least 58%, more preferably at least 60%, is in the green wavelength range and at least 25%, preferably at least 28%, more preferably at least 30%, is in the blue wavelength range. The second luminescent material 37 is configured to convert 3% to 30%, or 3% to 15%, of the LED filament light. The second luminescent material 37 may comprise a first (organic/QD) phosphor, such as a first (organic/QD) phosphor comprising Lumogen F-240, a second (organic) phosphor, such as a second (organic/QD) phosphor comprising Lumogen F-083, or both an first (organic/QD) phosphor and a second (organic/QD) phosphor comprising Lumogen F-240 and Lumogen F-083. The second luminescent material 37 may further be configured to provide no or substantially no or hardly any scattering of the LED filament light.

The translucent envelope 15 may be a glass envelope. In such a case the second luminescent material 37 may be provided as a coating on the glass envelope. The translucent envelope 15 may further comprise a neck 16. The neck 16 may comprise the second luminescent material 37. Alternatively, the neck 16 may be free from the second luminescent material 37.

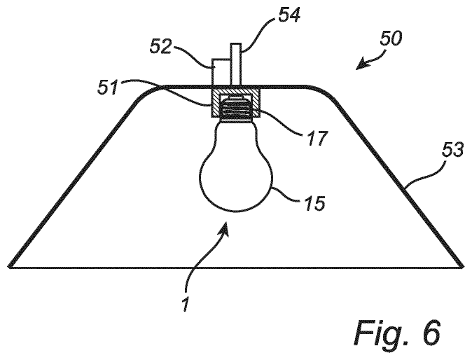

The LED filament lamp 1 further comprises a base 17, such as a cap. The translucent envelope 15 is connected to or mounted on the base 17. The base 17 is configured to connect the LED filament lamp 1 electrically and mechanically to a socket of a luminaire (cf. FIG. 6). Where provided, the neck 16 forms the part of the translucent envelope 15 that is connected or attached to the base 17.

The LED filament lamp 1 may further comprise threading 18 for connection to a socket and a terminal 19 for connection to a source of electrical energy. The threading 18 and the terminal 19 may form part of or be provided on the base 17.

The LED filament lamp 1 may further optionally comprise a driver or controller 30 configured for controlling the LED filament lamp 1. The driver or controller 30 may be an external unit, a unit arranged within the LED filament lamp 1 as shown on FIG. 1 or a combination of both such units. The controller 30 is configured to power the plurality or pluralities of LEDs 3-6 via the electrical circuitry (not visible) of the LED filament lamp 1. The controller 30 may further be configured for controlling at least one of the CCT of the LED filament lamp light L3 and the CRI of the LED filament lamp light L3. The controller 30 may also be configured for controlling other parameters related to the LED filament lamp light sources (that is, the plurality of LEDs 3-6) and the LED filament lamp light L3. As shown in FIG. 1, the controller 30 is arranged within the translucent envelope 15. The controller 30 may also be arranged inside the base 17 such that it is hidden from view.

The LED filament lamp 1 may further comprise an exhaust tube 31. The exhaust tube 31 is arranged, preferably centrally, in a stem 33 of the LED filament lamp 1.

The exhaust tube 31 is configured for sealing a gas between the translucent envelope 15 and the exhaust tube 31. The controller 30 may be arranged between the translucent envelope 15 and the exhaust tube 31.

The LED filament lamp 1 may further comprise one or two electrically conductive base wires 32. The one or two electrically conductive base wires 32 are separate from the at least two electrically conducting wires 25 and 26. In the embodiment shown in FIG. 1, the connection between the one or two electrically conductive base wires 32 and the electrically conductive wires 25 and 26 of each LED filament 21-24 is achieved by means of a respective wire segment 34 connected to the one or two electrically conductive base wires 32 at a first end. The one or two electrically conductive base wires 32 penetrate the exhaust tube 31 to be electrically connected at a second end (not visible on the Figs.) opposite to the first end to a driver 52 (cf. FIG. 6) or to the controller 30 or to a power source.

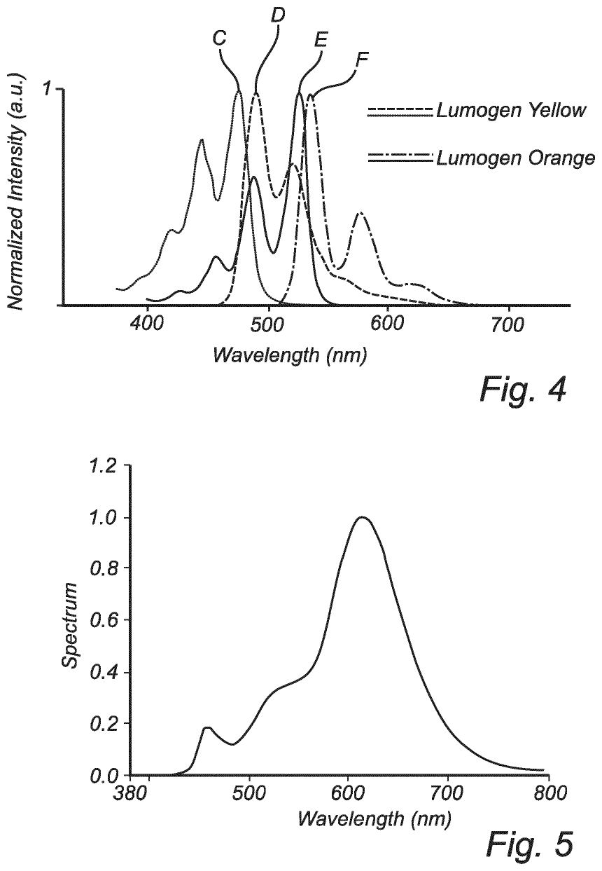

FIG. 4 illustrates the absorption coefficient and the emission spectrum of each of a number of different suitable phosphors plotted as normalized intensity as a function of the wavelength of incident light. The absorption coefficients are shown with dashed lines and the emission spectra are shown with full lines. The incident light is LED light with a Correlated Color Temperature (CCT) of 2200 K.

Graphs C and D indicate the absorption coefficient and the emission spectrum, respectively, of a Lumogen F-083 phosphor (i.e. second phosphor). Graphs E and F indicate the absorption coefficient and the emission spectrum, respectively, of a Lumogen F-240 phosphor (i.e. first phosphor).

FIG. 5 shows a graph illustrating the spectrum of light as a function of wavelength resulting from an exemplary LED filament lamp according to the invention and comprising a second luminescent material 37 as perceived by a viewer. It may be seen that the spectrum of light, or at least the dominating wavelengths of light in the said spectrum, corresponds to that of light perceived by a viewer as having an amber color.

Turning finally to FIG. 6, an exemplary luminaire in the form of a pendant 50 is shown. The pendant 50 comprises a LED filament lamp 1 according to any embodiment of the invention. In the embodiment shown, the LED filament lamp 1 is of the type shown in FIG. 1 and comprises substantially straight filaments. The filaments of such a LED filament lamp 1 may in other embodiments be filaments with another shape, such as, but not limited to, spiral-shaped, helix-shaped, meandering, twisted, flat and combinations thereof.

The pendant 50 further comprises a socket 51 for connecting the LED filament lamp 1 to the pendant 50. The socket 51 is adapted to cooperate with the base 17 of the LED filament lamp 1. The socket 51 may comprise a threading adapted to cooperate with the threading 18 of the LED filament lamp 1. The socket 51 may comprise a terminal adapted to cooperate with the terminal 19 of the LED filament lamp 1.

The pendant 50 may further comprise a driver 52 configured for controlling the LED filament lamp 1. The driver 52 may or may not be the same unit as the controller 30 described above. In other words, the driver 52 and the controller 30 may be integrated into one and the same driver or controller, or they may be mutually separate units. The driver 52 is configured to power the plurality of LED filaments 21-24 via the electrically conducting wires of the LED filament lamp 1. The driver 52 may further be configured for controlling at least one of the CCT of the LED filament lamp light L3 and the CRI of the LED filament lamp light L3. The driver 52 may also be configured for controlling other parameters related to the LED filament lamp light sources (that is, the plurality of LEDs 3-6) and the LED filament lamp light L3.

As shown in FIG. 6, the driver 52 is arranged on a reflector or screen 53 of the pendant 50. The driver may also be arranged within or incorporated into the reflector or screen 53. The pendant 50 further comprises an electrical wiring 54 for connection to a source of electricity, such as a mains.

It is noted that the pendant 50 shown in FIG. 6 is only one example of a luminaire according to the invention. Any suitable type of luminaire may be envisaged, such as but not limited to, a standing luminaire, a wall hung luminaire, a chandelier, a reading luminaire, an outdoor luminaire and a table luminaire.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A LED filament lamp providing, in operation, LED filament lamp light and comprising:
a LED filament emitting, in operation, LED filament light and comprising a plurality of LEDs emitting, in operation, LED light and arranged on an elongated carrier, an elongated encapsulant covering the plurality of LEDs and at least a part of the elongated carrier, wherein the elongated encapsulant comprises at least one of a first luminescent material configured to convert at least a part of the LED light into converted light and a light scattering material configured to scatter at least a part of the LED light into scattered light, wherein the LED filament light comprises the converted light and/or the scattered light,
a base configured to, electrically and mechanically, connect the LED filament lamp to a socket of a luminaire,
a translucent envelope at least partly enclosing said LED filament and mounted to the base,
wherein the translucent envelope comprises a second luminescent material, the second luminescent material comprising one or more of an organic phosphor and quantum dots distributed in a polymer matrix, wherein the second luminescent material is configured to convert a part of the LED filament light into converted LED filament light, and wherein the second luminescent material has an absorption in the visible wavelength range of which at least 80% is in the blue and green wavelength range, such that the translucent envelope is perceived as having an amber color, and
wherein the second luminescent material comprises one or more of:
a first phosphor configured to emit first phosphor light having a dominant wavelength in the wavelength range of 550-580 nm, and
a second phosphor configured to emit second phosphor light having a dominant wavelength in the wavelength range of 500-550 nm.

2. LED filament lamp according to claim 1, wherein the absorption of the second luminescent material in the visible wavelength range is higher in the blue wavelength range than in the green wavelength range.

3. LED filament lamp according to claim 1, wherein the second luminescent material has an absorption in the visible wavelength range of which at least 55% is in the green wavelength range and at least 25% is in the blue wavelength range.

4. LED filament lamp according to claim 1, wherein the second luminescent material is configured to convert 3% to 30%, of the LED filament light.

5. LED filament lamp according to claim 1, wherein the LED filament light is white light having a first correlated color temperature (CCT1), wherein CCT1≤2500 K.

6. LED filament lamp according to claim 1, wherein the LED filament light is white light having a first correlated color temperature (CCT1), wherein the LED filament lamp light is white light having a second correlated color temperature (CCT2), and wherein CCT2−CCT1≤500 K.

7. LED filament lamp according to claim 1, wherein the LED filament is free from an organic phosphor and quantum dots, and wherein the translucent envelope is free from an inorganic phosphor.

8. LED filament lamp according to claim 1, wherein the LED filament in an OFF-state, in which the LED filament does not emit LED filament light, and in an ON-state, in which the LED filament emits LED filament light, is visible through the translucent envelope.

9. LED filament lamp according to claim 1, wherein the first luminescent material comprises a green-yellow inorganic phosphor configured to emit green-yellow light and a red inorganic phosphor configured to emit red light.

10. LED filament lamp according to claim 9, wherein the green-yellow inorganic phosphor comprises YAG and/or LuAG phosphor, and wherein the red inorganic phosphor comprises KSiF phosphor.

11. LED filament lamp according to claim 1, wherein the elongated carrier is light-transmissive, and wherein a further encapsulant is provided on a second side of the carrier opposite to a first side of the carrier on which the plurality of LEDS is arranged, the further encapsulant comprises at least one of a further luminescent material configured to convert at least a part of the LED light and/or converted light into further converted light and a further light scattering material configured to scatter at least a part of the LED light and/or converted light into further scattered light.

12. LED filament lamp according to claim 1, wherein the translucent envelope comprises a glass envelope, and wherein the second luminescent material is provided as a coating on the glass envelope.

13. LED filament lamp according to claim, wherein the translucent envelope comprises a neck, wherein the neck forms a part of the translucent envelope being attached to the base and wherein the neck is free from the second luminescent material.

14. A luminaire comprising at least one LED filament lamp according to claim 1.
